(19) United States
(12) Patent Application Publication
(10) Pub. No.: US 2007/0290934 A1
(43) Pub. Date: Dec. 20, 2007

(54) Antenna device having high reception sensitivity over wide band

(75) Inventors: Yusuke Nakamura, Fukushima-ken (JP); Yukio Ohtaki, Fukushima-ken (JP)

Correspondence Address: BEYER WEAVER LLP, P.O. BOX 70250, OAKLAND, CA, 94612-0250, US

(73) Assignee: ALPS ELECTRIC CO., LTD.

(21) Appl. No.: 11/809,052

(22) Filed: May 30, 2007

(30) Foreign Application Priority Data
Jun. 20, 2006 (JP) 2006-170373
Nov. 9, 2006 (JP) 2006-303975

(51) Int. Cl. H01Q 1/24

(52) U.S. Cl. 343/702

(57) ABSTRACT

An antenna device is configured such that a chip antenna is mounted on a circuit substrate including first and second transmission lines, a high-frequency changeover switch, and a bias circuit. First ends of first and second radiation conductors that are wound around a base member of the chip antenna are connected to each other, and variable-capacitance elements are distributed in each of the radiation conductors. When an electrical connection between the input terminal and the output terminal of the high-frequency changeover switch is established, a feeding signal is supplied to the first transmission line to provide a high-band mode. When the electrical connection is disconnected, the feeding signal is supplied to the second transmission line to provide a low-band mode. In either band, a tuning voltage is supplied from the bias circuit to the variable-capacitance elements, whereby the tuning frequency of the antenna device can be changed.

### CLAIM OF PRIORITY

This application claims benefit of the Japanese Patent Application No. 2006-170373 filed on Jun. 20, 2006, and the Japanese Patent Application No. 2006-303975 filed on Nov. 9, 2006, which are hereby incorporated by reference.

### BACKGROUND OF THE INVENTION

1. Field of the Invention

The present invention relates to an antenna device including a chip antenna in which a band-shaped radiation conductor is wound around a base member made of a dielectric or magnetic material. More specifically, the present invention relates to a two-band antenna device in which variable-capacitance elements are distributed in a radiation conductor so that the antenna device can be tuned to a wide frequency band.

2. Description of the Related Art

In general, chip antennas configured such that a radiation conductor is spirally wound around a columnar base member made of a dielectric or magnetic material to tune to a desired frequency have been known. An antenna device configured such that in order to tune to a wide frequency band using this type of chip antenna, variable-capacitance elements are distributed in the radiation conductor and a tuning voltage based on a bias control signal is supplied to the variable-capacitance elements to change the capacitance value of the variable-capacitance elements to thereby change the resonant frequency of the radiation conductor according to the tuning voltage has been proposed in the related art (see, for example, Japanese Unexamined Patent Application Publication No. 2005-210564 (pages 4-6, FIG. 1)). In the proposed antenna device of the related art, the chip antenna is mounted on a circuit substrate having disposed thereon circuits such as a feeding circuit and a bias circuit, and a feeding unit of the radiation conductor of the chip antenna is connected with the feeding circuit so that a direct-current tuning voltage is supplied from the bias circuit to the variable-capacitance elements. Such a chip antenna that can be tuned to a wide band of frequencies can be easily mounted in a portable wireless device such as a mobile phone, and can be used as a receiving antenna for the ultra-high-frequency (UHF) band used for television broadcasting. It is therefore expected that the chip antenna will be of increasing practical value.

However, the above-described proposed antenna device of the related art in which variable-capacitance elements are distributed in a radiation conductor is a one-band antenna device and has a problem in that if the number of variable-capacitance elements increases to increase the frequency bandwidth with high reception sensitivity, the size of the antenna device also increases. Therefore, if all UHF-band television broadcasting signals are to be received using such an antenna device of the related art, it is difficult to reduce the size of the antenna device so that it can be mounted in a portable device such as mobile telephone.

### SUMMARY OF THE INVENTION

The present invention provides an antenna device having high reception sensitivity over a wide band without increasing its size.

An antenna device according to an aspect of the present invention includes a chip antenna in which a first radiation conductor and a second radiation conductor are wound in a band-like manner around a base member made of a dielectric or magnetic material so that first ends of the radiation conductors are connected to each other and a second end of the second radiation conductor is open-ended, and in which each of the first radiation conductor and the second radiation conductor is divided into a plurality of divided conductor sections and pairs of adjacent sections among the divided conductor sections are connected in series through variable-capacitance elements, wherein a circuit substrate on which the chip antenna is mounted includes a first transmission line for supplying a feeding signal to a node at which the first ends of the first and second radiation conductors are connected to each other, a second transmission line for supplying the feeding signal to a second end of the first radiation conductor, a high-frequency switching circuit for opening and closing an electrical connection between an input terminal connected to the second transmission line and an output terminal connected to the first transmission line, and a bias circuit for supplying a tuning voltage based on a bias control signal to the variable-capacitance elements to change a capacitance value of the variable-capacitance elements, wherein the second radiation conductor can be resonated in a high band when the high-frequency switching circuit establishes an electrical connection between the input terminal and the output terminal, and the first and second radiation conductors can be resonated in a low band when the high-frequency switching circuit disconnects an electrical connection between the input terminal and the output terminal, and wherein a tuning frequency is changed according to the tuning voltage regardless of whether the high band or the low band is selected.

In the antenna device having the above-described structure, when the high-frequency switching circuit establishes an electrical connection between the input terminal and the output terminal, a feeding signal is supplied through the first transmission line to the node at which the first ends of the first and second radiation conductors are connected to each other, and the second radiation conductor whose second end is open-ended can be resonated in a predetermined frequency band (high band). When the high-frequency switching circuit disconnects an electrical connection between the input terminal and the output terminal, the feeding signal is not supplied to the first transmission line but is supplied to the second end of the first radiation conductor through the second transmission line. Therefore, the overall first and second radiation conductor can be resonated in a frequency band (low band) lower than the high band. That is, the high-frequency switching circuit opens and closes an electrical connection between the input terminal and the output terminal to allow any selection between the high-band mode and the low-band mode. By supplying a feeding signal corresponding to the selected band, a two-band configuration can be realized. Further, regardless of whether the high band or the low band is selected, a tuning voltage is supplied from the bias circuit, whereby the tuning frequency of the corresponding band can be appropriately changed in a range of the varying capacitance values of the variable-capacitance elements. Therefore, high reception sensitivity can be obtained over a wide frequency band without increasing the size of the antenna device.

The circuit substrate on which the chip antenna is mounted may be an antenna substrate having an external connection terminal connected to a wiring pattern of an external circuit substrate (base substrate), and at least the high-frequency switching circuit and the bias circuit may be disposed on the antenna substrate. Therefore, the antenna device in which the chip antenna is mounted on the antenna substrate to form a unit (or module) can be easily disposed on the base substrate, and can be commonly used for various base substrates that are different in circuit structure but are equivalent in antenna performance. Consequently, an antenna device with high usability and versatility can be achieved.

The bias circuit may include a boosting unit boosting a voltage level of the bias control signal to a predetermined magnitude. Therefore, even if a power supply voltage on the base substrate is low, the tuning voltage of the antenna device can be set higher than the power supply voltage. There will be no problem with the control of the capacitance value of the variable-capacitance elements if the antenna device is mounted in a portable wireless device whose power supply voltage is set low.

The divided conductor section of the second radiation conductor that is the closest to the node may be divided into a plurality of narrow conductor subsections connected in series, and the circuit substrate may include a selection circuit capable of selectively establishing an electrical connection between one of the narrow conductor subsections and the first transmission line. Therefore, the frequency bandwidth of the second radiation conductor that can be resonated when the high band is selected can be adjusted. The selection circuit may be, for example, a changeover switch disposed between the narrow conductor subsections and the first transmission line so that an electrical connection between one of the narrow conductor subsections and the first transmission line can be established using the changeover switch. Alternatively, the selection circuit may be a chip component, such as a chip capacitor or a zero-ohm chip resistor, disposed between one of the narrow conductor subsections and the first transmission line.

Accordingly, the high-frequency switching circuit opens and closes an electrical connection between the input terminal and the output terminal to allow any selection between the high band and the low band. By supplying a feeding signal corresponding to the selected band, a two-band antenna device can be achieved. Further, regardless of whether the high band or the low band is selected, a tuning voltage is supplied from the bias circuit, whereby the tuning frequency of the corresponding band can be appropriately changed in a range of the varying capacitance values of the variable-capacitance elements. Therefore, high reception sensitivity can be obtained over a wide frequency band without increasing the size of the antenna device.

### BRIEF DESCRIPTION OF THE DRAWINGS

FIG. 1 is an external view of an antenna device according to a first exemplary embodiment of the present invention that is mounted on a base substrate;

FIG. 2 is an equivalent circuit diagram of the antenna device in a low-band mode;

FIG. 3 is an equivalent circuit diagram of the antenna device in a high-band mode;

FIG. 4 is an equivalent circuit diagram of an antenna device according to a second exemplary embodiment of the present invention in a low-band mode;

FIG. 5 is an equivalent circuit diagram of the antenna device in a high-band mode;

FIG. 6 is an equivalent circuit diagram of an antenna device according to a third exemplary embodiment of the present invention in a low-band mode;

FIG. 7 is an equivalent circuit diagram of the antenna device in a high-band mode;

FIG. 8 is an equivalent circuit diagram of an antenna device according to a fourth exemplary embodiment of the present invention in a low-band mode; and

FIG. 9 is an equivalent circuit diagram of the antenna device in a high-band mode.

### DESCRIPTION OF THE PREFERRED EMBODIMENTS

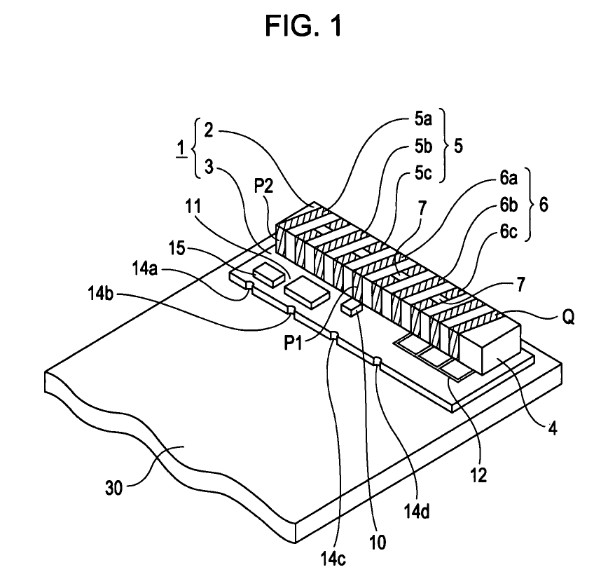

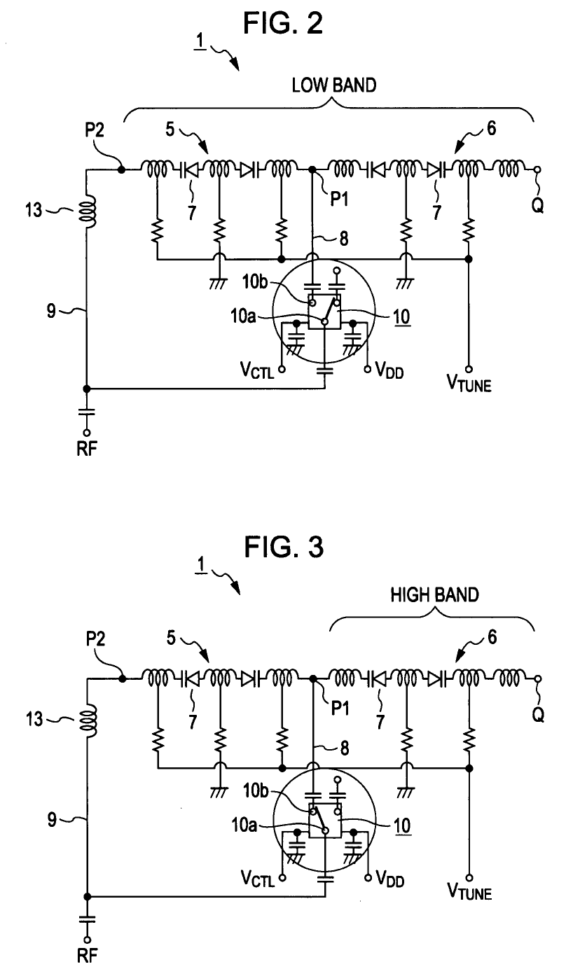

Exemplary embodiments of the present invention will be described with reference to the drawings. FIG. 1 is an external view of an antenna device 1 according to a first exemplary embodiment of the present invention that is mounted on a base substrate; FIG. 2 is an equivalent circuit diagram of the antenna device 1 in a low-band mode; and FIG. 3 is an equivalent circuit diagram of the antenna device 1 in a high-band mode.

The antenna device 1 according to the first exemplary embodiment is configured such that a chip antenna 2 is mounted on an antenna substrate 3 to form a unit (or module). As shown in FIG. 1, the antenna substrate 3 is mounted on a base substrate 30 serving as an external circuit substrate. The base substrate 30 is a circuit substrate housed in a portable wireless device such as a mobile phone, and the antenna device 1 is used as a receiving antenna for the UHF band used for television broadcasting. Although not shown in FIG. 1, circuits for the antenna device 1, such as a tuner circuit, are disposed on the base substrate 30.

The chip antenna 2 of the antenna device 1 includes as main components a columnar base member 4 made of a dielectric material, first and second radiation conductors 5 and 6 spirally wound around the outer surface of the base member 4, and a plurality of variable-capacitance elements (varactor diodes) 7 distributed over lines defined by the first and second radiation conductors 5 and 6. First ends of the first and second radiation conductors 5 and 6 are connected in series at a node P1. A second end of the first radiation conductor 5 serves as a feeding end P2, and a second end of the second radiation conductor 6 serves as an open end Q. The first radiation conductor 5 is divided into a plurality of divided conductor sections 5a to 5c, and the spaces between pairs of adjacent divided conductor sections (between the divided conductor sections 5a and 5b and between the divided conductor sections 5b and 5c) are connected in series through the variable-capacitance elements 7. The second radiation conductor 6 is also divided into a plurality of divided conductor sections 6a to 6c, and the spaces between pairs of adjacent divided conductor sections (between the divided conductor sections 6a and 6b and between the divided conductor sections 6b and 6c) are connected in series through the variable-capacitance elements 7. The chip antenna 2 is fixedly positioned on the antenna substrate 3, and appropriate portions of the first and second radiation conductors 5 and 6 are soldered to a wiring pattern of the antenna substrate 3. The base member 4 may be made of a magnetic material and may be plate-shaped.

The antenna substrate 3 has disposed thereon a first transmission line 8 for supplying a feeding signal to the node P1 between the first and second radiation conductors 5 and 6, a second transmission line 9 for supplying a feeding signal to the feeding end P2 of the first radiation conductor 5, a high-frequency changeover switch 10 for opening or closing an electrical connection between an input terminal 10a and an output terminal 10b of the high-frequency changeover switch 10, a bias circuit 11 for supplying a tuning voltage based on a bias control signal to the variable-capacitance elements 7 of the chip antenna 2 to change the capacitance value of the variable-capacitance elements 7, a frequency-adjustment pattern 12 connected to the second radiation conductor 6, a matching circuit including an inductor 13, a capacitor, etc., for matching the input impedance with the characteristic impedance, and external connection terminals 14a to 14d soldered to a wiring pattern of the base substrate 30.

The external connection terminals 14a to 14d are connected to a power supply circuit or tuner circuit (not shown) disposed on the base substrate 30. For example, a power supply voltage V_{DD} is input to the external connection terminal 14a from the power supply circuit, and a feeding signal RF is input to the external connection terminal 14b from the tuner circuit. A bias control signal for a tuning voltage V_{TUNE} is input to the external connection terminal 14c from the tuner circuit, and a switch control signal V_{CTL} for opening and closing the high-frequency changeover switch 10 is input to the external connection terminal 14d from the tuner circuit. The frequency-adjustment pattern 12 shown in FIG. 1 is trimmed at a desired position to finely adjust the electrical length of the second radiation conductor 6. This fine adjustment would avoid variations in antenna performance.

The input terminal 10a of the high-frequency changeover switch 10 is connected to a feeding circuit of the tuner circuit, and is also connected to the second transmission line 9. The output terminal 10b of the high-frequency changeover switch 10 is connected to the first transmission line 8. In a switch-on state where an electrical connection between the input terminal 10a and the output terminal 10b is established, the feeding signal RF can be supplied to the node P1 through the first transmission line 8. In a switch-off state where an electrical connection between the input terminal 10a and the output terminal 10b is disconnected, the feeding signal RF can be supplied to the feeding end P2 through the second transmission line 9. The high-frequency changeover switch 10 is set to the switch-on state for a period in which the switch control signal V_{CTL} is supplied, and is set to the switch-off state for a period in which the switch control signal V_{CTL} is not supplied.

The bias circuit 11 includes a DC/DC converter 15 for boosting the power supply voltage V_{DD} (e.g., 3 V) to a constant operating voltage (e.g., 5 V), an field-effect transistor (FET) switch circuit for generating a boosted bias signal from the output (operating voltage) of the DC/DC converter 15 and the bias control signal (pulse width modulation signal), and a smoothing circuit for smoothing the boosted bias signal to generate a direct-current tuning voltage V_{TUNE}. The bias circuit 11 can change the tuning voltage V_{TUNE} within a range of, for example, 0.2 V to 4.8 V according to the pulse width of the bias control signal. The tuning voltage V_{TUNE} is supplied to the variable-capacitance elements 7 to change the capacitance value of the variable-capacitance elements 7, whereby the tuning frequency of the chip antenna 2 can be appropriately changed.

The operation of the antenna device 1 having the above-described structure will be described. As shown in FIG. 2, the antenna device 1 is configured such that the feeding signal RF is supplied to the feeding end P2 through the second transmission line 9 in the switch-off state where the high-frequency changeover switch 10 disconnects an electrical connection between the input terminal 10a and the output terminal 10b. Therefore, the overall first and second radiation conductors 5 and 6 can be resonated in a predetermined frequency band (low band). By changing the tuning voltage V_{TUNE} applied to the variable-capacitance elements 7 in the low band, the tuning frequency of the chip antenna 2 (the resonant frequency of the overall first and second radiation conductors 5 and 6) can be appropriately changed.

As shown in FIG. 3, in the switch-on state where the high-frequency changeover switch 10 establishes an electrical connection between the input terminal 10a and the output terminal 10b, the feeding signal RF can be supplied to the node P1 through the first transmission line 8. Therefore, the second radiation conductor 6 can be resonated in a frequency band (high band) higher than the low band. In the high-band mode, the feeding signal RF is not substantially supplied to the second transmission line 9 in which the inductor 13 is connected. By changing the tuning voltage V_{TUNE} applied to the variable-capacitance elements 7 in the high-band mode, the tuning frequency of the chip antenna 2 (the resonant frequency of the second radiation conductor 6) can be appropriately changed.

Accordingly, the antenna device 1 according to the first exemplary embodiment is configured such that the high-frequency changeover switch 10 opens and closes an electrical connection between the input terminal 10a and the output terminal 10b to allow any selection between the high-band mode and the low-band mode. By supplying the feeding signal RF corresponding to the selected band, a two-band configuration that can be used in either a high-frequency band or a low-frequency band can be realized. Further, regardless of whether the high band or the low band is selected, the tuning voltage V_{TUNE} is supplied from the bias circuit 11, whereby the tuning frequency of the corresponding band can be changed in a range of the varying capacitance values of the variable-capacitance elements 7. Therefore, the antenna device 1 can obtain high reception sensitivity over a wide frequency band while ensuring a compact design that allows the antenna device 1 to be easily mounted in a portable wireless device, and can be suitably used as a receiving antenna for the UHF band used for television broadcasting.

Since the antenna device 1 is a unitized module formed by mounting the chip antenna 2 on the antenna substrate 3, the antenna device 1 can be easily disposed on the base substrate 30, and can be commonly used for various base substrates 30 that are different in circuit structure but are equivalent in antenna performance. High usability and versatility can therefore be attained. If it is not necessary to form the antenna device 1 as a unit using an antenna-specific substrate, the chip antenna 2 may be directly mounted on the base substrate 30 on which the transmission lines 8 and 9, the high-frequency changeover switch 10, the bias circuit 11, etc., are disposed.

Furthermore, in the antenna device 1, the bias circuit 11 includes the DC/DC converter 15 for boosting the voltage level of the bias control signal to a predetermined magnitude. Therefore, even if a power supply voltage on the base substrate 30 is low, the tuning voltage V_{TUNE} of the antenna device 1 can be set higher than the power supply voltage. There will be no problem with the control of the capacitance value of the variable-capacitance elements 7 if the antenna device 1 is mounted in a potable wireless device whose power supply voltage is set low.

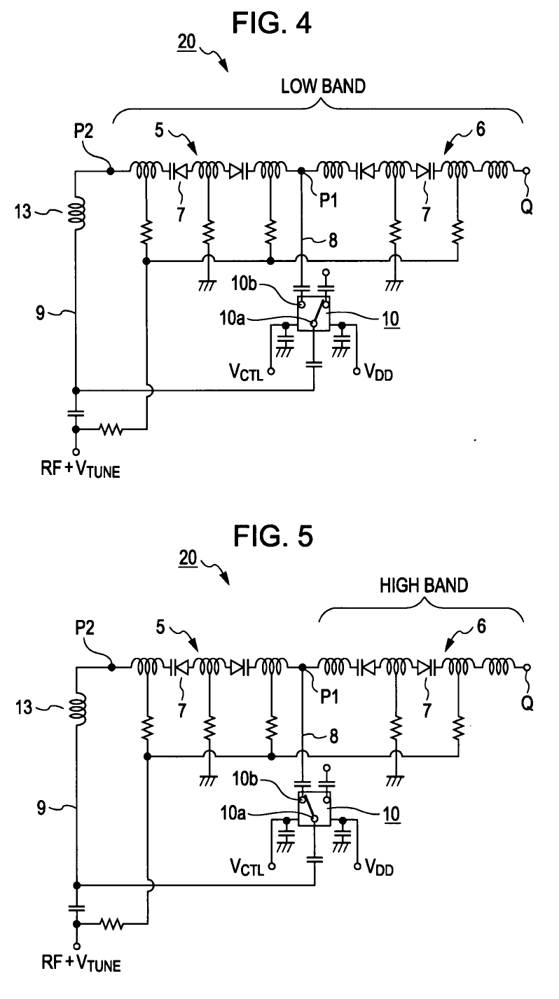

FIG. 4 is an equivalent circuit diagram of an antenna device 20 according to a second exemplary embodiment of the present invention in a low-band mode, and FIG. 5 is an equivalent circuit diagram of the antenna device 20 in a high-band mode, in which portions corresponding to those shown in FIGS. 2 and 3 are represented by the same reference numerals and a redundant description thereof is thus omitted.

The antenna device 20 according to the second exemplary embodiment has a circuit structure in which a direct-current tuning voltage V_{TUNE} superimposed on a feeding signal RF is supplied to the vicinity of the chip antenna, thus providing a simple layout of the wiring pattern on the base substrate. Also in the antenna device 20 of the second exemplary embodiment, as shown in FIG. 4, the overall first and second radiation conductors 5 and 6 can be resonated in a low band when the high-frequency changeover switch 10 disconnects an electrical connection between the input terminal 10a and the output terminal 10b. As shown in FIG. 5, the second radiation conductor 6 can be resonated in a high band when the high-frequency changeover switch 10 establishes an electrical connection between the input terminal 10a and the output terminal 10b. As in the first exemplary embodiment described above, regardless of whether the high band or the low band is selected, the tuning voltage V_{TUNE} is supplied to change the capacitance value of the variable-capacitance elements 7, whereby the tuning frequency of the corresponding band can be changed.

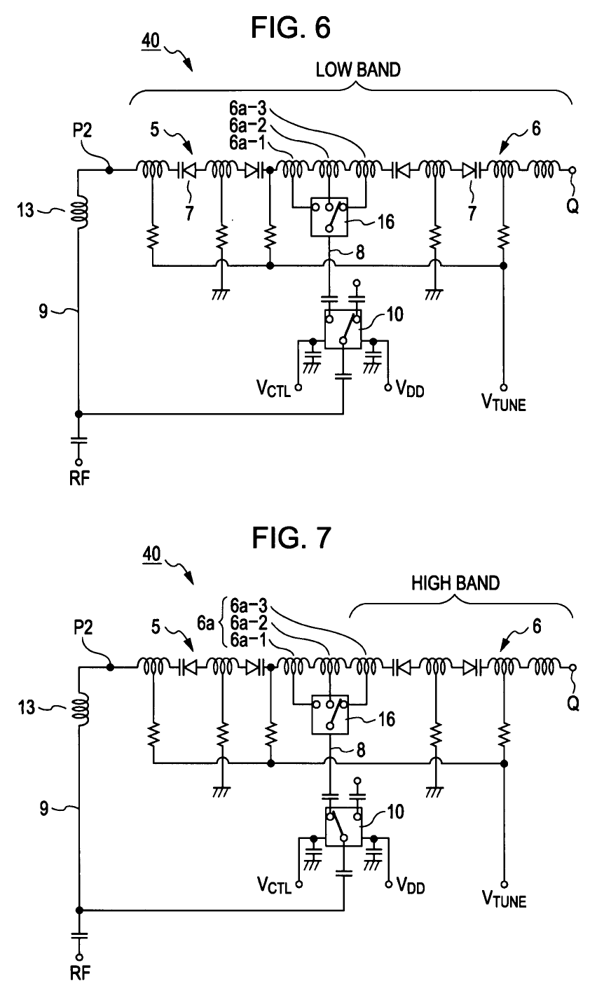

FIG. 6 is an equivalent circuit diagram of an antenna device 40 according to a third exemplary embodiment of the present invention in a low-band mode, and FIG. 7 is an equivalent circuit diagram of the antenna device 40 in a high-band mode, in which portions corresponding to those shown in FIGS. 2 and 3 are represented by the same reference numerals and a redundant description thereof is thus omitted.

The antenna device 40 according to the third exemplary embodiment is different from the antenna device 1 according to the first exemplary embodiment in that the divided conductor section 6a of the second radiation conductor 6 that is the closest to the node P1 is further divided into a plurality of (e.g., three) narrow conductor subsections 6a-1, 6a-2, and 6a-3 connected in series, and in that an electrical connection between one of the narrow conductor subsections 6a-1, 6a-2, and 6a-3 and the first transmission line 8 can be selectively established using a changeover switch 16 mounted on the antenna substrate 3. The other structure is basically the same as that in the first exemplary embodiment. The changeover switch 16 is a three-position changeover switch having a movable contact whose contact position can be changed between three fixed contacts, and the terminal leading from the movable contact is connected to the first transmission line 8, and the terminals leading from the three fixed contacts are connected to the narrow conductor subsections 6a-1, 6a-2, and 6a-3. In the example shown in FIGS. 6 and 7, an electrical connection between the first transmission line 8 and the narrow conductor subsection 6a-3 is established through the changeover switch 16. Alternatively, an electrical connection between the first transmission line and any other narrow conductor subsection 6a-1 or 6a-2 can be changed by moving the movable contact of the changeover switch 16.

Also in the antenna device 40 according to the third exemplary embodiment having the above-described structure, as shown in FIG. 6, in the switch-off state where the high-frequency changeover switch 10 disconnects an electrical connection between the input terminal 10a and the output terminal 10b, the feeding signal RF can be supplied to the feeding end P2 through the second transmission line 9. Therefore, the overall first and second radiation conductors 5 and 6 can be resonated in a low band. Further, as shown in FIG. 7, in the switch-on state where the high-frequency changeover switch 10 establishes an electrical connection between the input terminal 10a and the output terminal 10b, the feeding signal RF can be supplied to the narrow conductor subsection 6a-3 of the divided conductor section 6a through the changeover switch 16 from the first transmission line 8. Therefore, a portion of the second radiation conductor 6 that extends from the narrow conductor subsection 6a-3 to the open end Q can be resonated in the high band. As in the first exemplary embodiment described above, regardless of whether the high band or the low band is selected, the tuning voltage V_{TUNE} is supplied to change the capacitance value of the variable-capacitance elements 7, whereby the tuning frequency of the corresponding band can be changed.

Furthermore, the antenna device 40 is configured to allow selection between electrical connections between the first transmission line 8 and the narrow conductor subsections 6a-1, 6a-2, and 6a-3 of the second radiation conductor 6 using the changeover switch 16 to change the length of the portion of the second radiation conductor 6 resonated when the high band is selected. Therefore, the frequency bandwidth of the second radiation conductor 6 that can be resonated when the high band is selected can be adjusted according to the radio propagation conditions of the region where a portable wireless device including the antenna device 40 is used. That is, as described above, the second radiation conductor 6 is resonated in the highest frequency band (high band) when an electrical connection between the first transmission line 8 and the narrow conductor subsection 6a-3 is established. When an electrical connection between the first transmission line 8 and the narrow conductor subsection 6a-2 is established, a portion of the second radiation conductor 6 extending from the narrow conductor subsection 6a-2 to the open end Q can be resonated in a slightly lower frequency band (high band). When an electrical connection between the first transmission line 8 and the narrow conductor subsection 6a-1 is established, a portion of the second radiation conductor 6 extending from the narrow conductor subsection 6a-1 to the open end Q can be resonated in a further lower frequency band (high band).

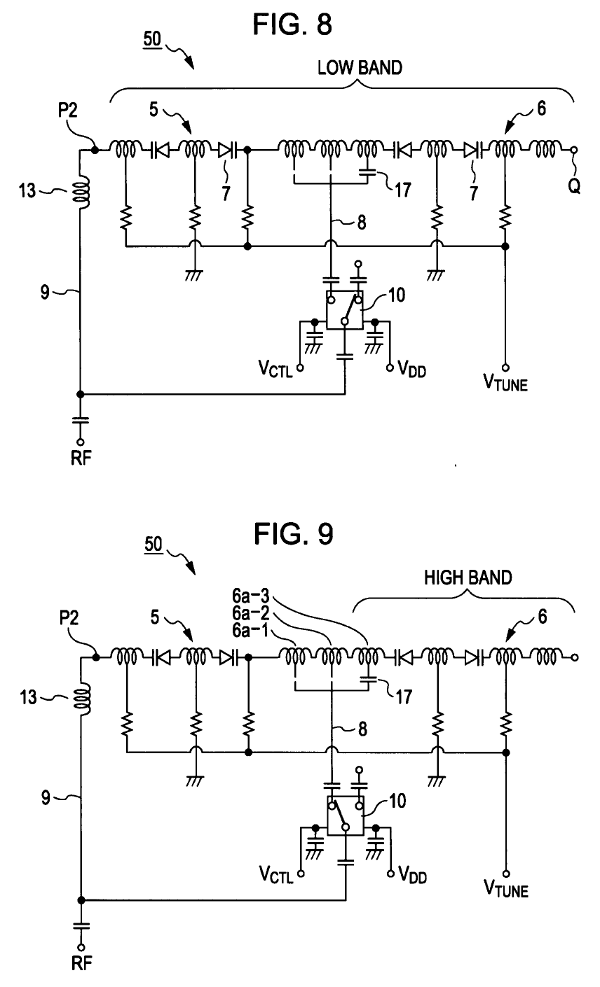

FIG. 8 is an equivalent circuit diagram of an antenna device 50 according to a fourth exemplary embodiment of the present invention in a low-band mode, and FIG. 9 is an equivalent circuit diagram of the antenna device 50 in a high-band mode, in which portions corresponding to those shown in FIGS. 6 and 7 are represented by the same reference numerals and a redundant description thereof is thus omitted.

In the antenna device 50 according to the fourth exemplary embodiment, an electrical connection between one of the narrow conductor subsections 6a-1, 6a-2, and 6a-3 of the second radiation conductor 6 and the first transmission line 8 is established through a chip capacitor 17 mounted on the antenna substrate 3. The other structure is basically the same as that in the third exemplary embodiment described above. Also in the antenna device 50 of the fourth exemplary embodiment, as shown in FIG. 8, when the high-frequency changeover switch 10 disconnects an electrical connection between the input terminal 10a and the output terminal 10b, the overall first and second radiation conductors 5 and 6 can be resonated in the low band. As shown in FIG. 9, when the high-frequency changeover switch 10 establishes an electrical connection between the input terminal 10a and the output terminal 10b, the second radiation conductor 6 can be resonated in the high band. As in the first exemplary embodiment described above, regardless of whether the high band or the low band is selected, the tuning voltage V_{TUNE} is supplied to change the capacitance value of the variable-capacitance elements 7, whereby the tuning frequency of the corresponding band can be changed.

Furthermore, the antenna device 50 is configured such that the mounting position of the chip capacitor 17 is selected to change an electrical connection between one of the narrow conductor subsections 6a-1, 6a-2, and 6a-3 and the first transmission line 8, whereby the length of the portion of the second radiation conductor 6 resonated when the high band is selected can be changed. Therefore, the frequency bandwidth of the second radiation conductor 6 that can be resonated when the high band is selected can be adjusted according to the radio propagation conditions of the region where a portable wireless device including the antenna device 50 is used. A zero-ohm chip resistor may be used in place of the chip capacitor 17, or three selection patterns connecting the narrow conductor subsections 6a-1, 6a-2, and 6a-3 to the first transmission line 8 may be defined in advance on the antenna substrate 3 and two selection patterns, except for one of the selection patterns, may be cut.

What is claimed is:

1. An antenna device comprising:
a chip antenna in which a first radiation conductor and a second radiation conductor are wound in a band-like manner around a base member made of a dielectric or magnetic material so that first ends of the radiation conductors are connected to each other and a second end of the second radiation conductor is open-ended, and in which each of the first radiation conductor and the second radiation conductor is divided into a plurality of divided conductor sections and pairs of adjacent sections among the divided conductor sections are connected in series through variable-capacitance elements,
wherein a circuit substrate on which the chip antenna is mounted includes a first transmission line for supplying a feeding signal to a node at which the first ends of the first and second radiation conductors are connected to each other, a second transmission line for supplying the feeding signal to a second end of the first radiation conductor, a high-frequency switching circuit for opening and closing an electrical connection between an input terminal connected to the second transmission line and an output terminal connected to the first transmission line, and a bias circuit for supplying a tuning voltage based on a bias control signal to the variable-capacitance elements to change a capacitance value of the variable-capacitance elements,
wherein the second radiation conductor can be resonated in a high band when the high-frequency switching circuit establishes an electrical connection between the input terminal and the output terminal, and the first and second radiation conductors can be resonated in a low band when the high-frequency switching circuit disconnects an electrical connection between the input terminal and the output terminal, and wherein a tuning frequency is changed according to the tuning voltage regardless of whether the high band or the low band is selected.

2. The antenna device according to claim 1, wherein the circuit substrate is an antenna substrate having an external connection terminal connected to a wiring pattern of an external circuit substrate, and at least the high-frequency switching circuit and the bias circuit are disposed on the antenna substrate.

3. The antenna device according to claim 1, wherein the bias circuit includes boosting means for boosting a voltage level of the bias control signal to a predetermined magnitude.

4. The antenna device according to claim 1, wherein the divided conductor section of the second radiation conductor that is the closest to the node is divided into a plurality of narrow conductor subsections connected in series, and the circuit substrate includes a selection circuit capable of selectively establishing an electrical connection between one of the narrow conductor subsections and the first transmission line.

5. The antenna device according to claim 4, wherein the selection circuit is a changeover switch placed between the narrow conductor subsections and the first transmission line.

6. The antenna device according to claim 4, wherein the selection circuit is a chip component placed between one of the narrow conductor subsections and the first transmission line.
